(19) United States
(12) Patent Application Publication
(10) Pub. No.: US 2022/0074795 A1
(43) Pub. Date: Mar. 10, 2022

(54) SYSTEM FOR MEASURING JUNCTION TEMPERATURE OF PHOTONICS DEVICES

(71) Applicant: OZYEGIN UNIVERSITESI, Istanbul (TR)

(72) Inventors: Mehmet ARIK, Istanbul (TR); Enes TAMDOGAN, Istanbul (TR); Burak OZLUK, Istanbul (TR); Ahmet Mete MUSLU, Istanbul (TR)

(73) Assignee: OZYEGIN UNIVERSITESI, Istanbul (TR)

(21) Appl. No.: 17/417,821

(22) PCT Filed: Dec. 25, 2018
(86) PCT No.: PCT/TR2018/050889

§ 371 Date: Jun. 24, 2021

(51) Int. Cl. G01K 7/01; G01K 15/00

(52) U.S. Cl. CPC G01K 7/01; G01K 2217/00; G01K 15/005

(57) ABSTRACT

A system for measuring the junction temperature of a photonics device comprising a) a test chamber, wherein a photonics device to be tested is placed inside, b) at least one heater, c) at least one temperature sensor, d) a source-meter configured to apply a driving current to the photonics device in order to read the corresponding forward voltage value at that temperature, e) a power supply, f) a control system and g) a software configured to start and control the measurements with either predefined default settings or the settings entered by the user.

### TECHNICAL FIELD OF THE INVENTION

The present invention relates to a system and a method for measuring junction temperature of photonics devices such as light emitting diodes and lasers.

### BACKGROUND OF THE INVENTION

As electronic packages are getting smaller day by day, generated heat fluxes are also becoming more intense and causes serious lifetime and performance issues on consumer devices. Light emitting diodes as photonic devices are also one of these photonics products and they are the future of display and lighting industry. Although the light output of photonic devices is more efficient than the counterparts, they still dissipate about 80% of their energy input as heat. In other words, only about 20% of the energy is converted into visible light.

Photonic devices of the present invention like other photonics devices (lasers, vcsels etc) are semiconductor diodes which consist of two semiconductor materials called N-type and P-type. The interface between these two types is called as PN junction where the P side contains excess holes and N side contains excess electrons. Light is produced as a result of combination of these free electrons and electron holes at the PN junction region when electrical potential is applied. As stated before that a huge amount of this electrical energy is converted into heat at the PN junction region while remaining energy converts into visible light.

Considering the fact that the light output and durability of photonic devices are critically affected by thermal issues, thus it is very important to keep photonic devices as cool as possible. To be able to design such systems, the first task is to determine the junction temperature of photonics devices so that new methods or designs for future photonics products will be easily tested and necessary improvements will be made according to thermal data received from the junction itself.

However, existing temperature measurement devices are quite expensive for most of the device manufacturers, thermal engineers and designers who need to measure only the junction temperature of devices. Known junction temperature measurement systems; for example, use a thermal transient test technique. This technique involves a thermal characterization technique with high sampling rate and resolution of data collection, such as heat flow path construction, die attach qualification, and material property identification, all of which make the product quite expensive.

Also, said thermal characterization uses a structure function based on the assumption of one dimensional heat flow path. However, in various types of devices, there are thermal masses on top of the photonic module such as phosphor and attached lens that change the heat flux symmetry. This issue brings difficulties for the interpretation of the structural function and leads to limitations especially for the coated devices such as white photonic products and etc.

Furthermore, since thermal resistances are used in these devices for the junction temperature measurement, the resistance between the test sample and the test system such as thermal interface material and etc. has to be well defined especially for comparable studies. For this reason, it is very important to own similar boundary conditions thus resistance between photonics product and cold plate in test system for comparable measurements. In addition, thermal resistance of this material should be known or measured since the existence of this material in measurement technique affects the measurement results and brings additional uncertainty.

Consequently, there is a need in the state of the art for affordable, easy to produce and reliable systems which greatly facilitates thermal, optical and electrical design of future photonics products as a result of junction temperature measurements.

### BRIEF DESCRIPTION OF THE FIGURES

FIG. 1 shows the schematic illustration of a system comprising;
a test chamber (1), heaters and coolers (2), temperature sensors (3), a power supply (4), a source-meter(s) (5), a control system (6), software (7) and robotic arm (8).

FIG. 2 Robotic arm schematic over a photonic devices and PCB

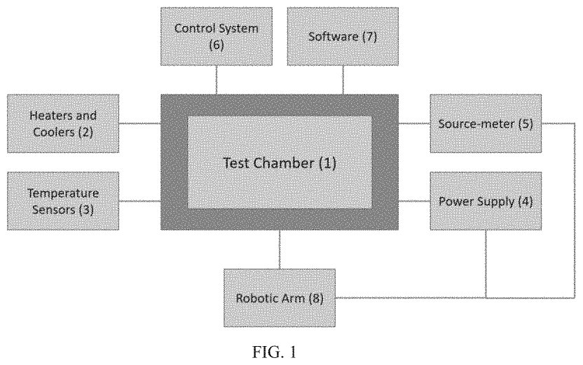

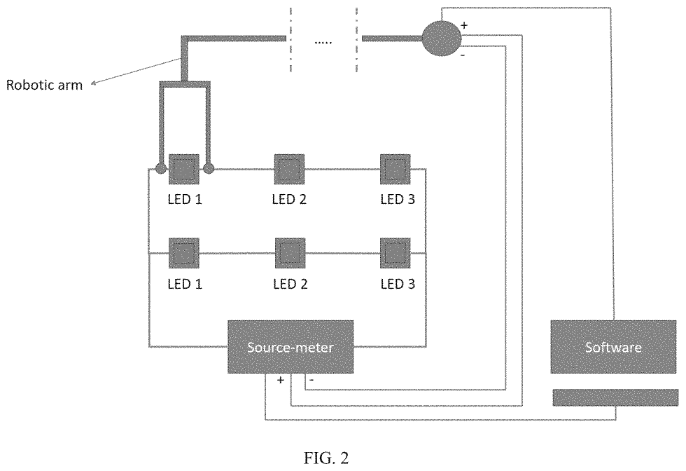

### BRIEF DESCRIPTION OF THE INVENTION

The present invention provides a computer implemented method to determine the junction temperatures of photonics devices such as LEDs in an efficient and reliable way in terms of accuracy of the performed measurements. The present invention further relates a system which is configured to perform the said method.

In one embodiment of the present invention a computer implemented method for measuring junction temperature is provided wherein the method comprises the steps of:
a) placing a photonic device to be tested into a test chamber (1)
b) adjusting calibration and pulse test settings in a software (7) associated with said test chamber (1)
c) heating or cooling the chamber at a desired speed and temperature
d) performing calibration phase measurements
e) performing pulse phase measurements
f) determining the junction temperature of the photonic device
g) monitoring the determined junction temperature by a software (7)

In another embodiment of the present invention a system comprising a computer program configured to perform the method described above is provided wherein the system comprises:
a) a test chamber (1), wherein at least one photonic device to be tested is placed inside,
b) a source-meter (5) configured to apply a driving current to the photonic device in order to read the corresponding forward voltage value at that temperature,
c) at least one heater (2) configured to heat the test chamber (1),
d) at least one temperature sensor (3), preferably located inside the test chamber, configured to measure the temperature of the test chamber (1),
e) a control system (6) configured to convert the measured temperature value to digital data and send feedback to the power supply (4),
f) a power supply (4) configured to give required energy to the heaters (2) according to the feedback received from the control system (6) for keeping the test chamber at the desired temperature (1),
g) a software (7) configured to start and control the measurements with either predefined default settings or the settings entered by the user, and to monitor the measurement data.

### DETAILED DESCRIPTION OF THE INVENTION

The present invention provides a system and a method for measuring the junction temperature of photonics which is the most vital need for the design of photonics products. The present invention also provides a temperature controlled environment for other purposes with a sensitive controller beyond measuring the junction temperature.

The system provided by the present invention is especially useful in photonics technologies, particularly in the research and development activities on the optical, electrical and thermal designs of photonics systems (e.g. LEDs).

In one embodiment of the present invention, the system for measuring the junction temperature of photonics comprises a test chamber (1), at least one heater (2), at least one temperature sensor(3), a power supply (4), a source-meter (5), a control system (6), a software package (7) and a robotic arm (8). In another embodiment of the present invention said system further comprises at least one cooler.

Test chamber is used for controlling the conditions, particularly the temperature of the environment of photonics to be tested. Since it provides a closed environment for the photonics placed inside, a user who aims to measure the junction temperature can control measurements by adjusting test settings in a computer program.

The system of the present invention comprises at least one heater connected to the test chamber (1), said heater is preferably placed inside the chamber and/or on the inner walls or outer walls of the chamber for heating up the test chamber to set a certain temperature inside. In one embodiment of the present invention heaters are placed on the walls of the chamber. In another embodiment, the system of the present invention further comprises at least one cooler connected to the test chamber, preferably placed inside the chamber and/or on the inner walls or outer walls of the chamber for cooling down the test chamber to set a certain temperature inside.

Moreover, a thermocouple (temperature sensor) is used to sense the temperature of the ambient air inside the chamber or of the walls of the chamber. In one embodiment of the present invention, temperature sensors, preferably thermocouples or thermistors are placed on the walls on which the heaters are located. In another embodiment of the present invention, a number of temperature sensors are placed at various locations inside the chamber.

Power supply is used to give the required energy to the heaters and/or coolers to increase and/or reduce the temperature of the test chamber to reach the desired level.

Source-meter is an apparatus that applies a driving current or voltage and measures both corresponding forward voltage and current values. According to the present invention, junction temperature is measured by means of forward voltage value of a device at a selected temperature. For this purpose, a source-meter, for example Keithley 2420 Sourcemeter® or a simple electronics circuit can be used.

A control system such as PLC (Programmable Logic Controllers) is configured to collect the measured temperature data from temperature sensor(s), convert it into digital data and send feedback to the power supply. According to the feedback received by the control system from temperature sensors, heaters and coolers give or absorb the sufficient amount of thermal load on or from the chamber walls so that total measurement time is reduced and overheating is avoided.

A custom software package is associated with the system in which a user can control measurements by adjusting test settings. Thus, the system is user friendly in terms of reducing measurement time greatly and ensuring the accuracy of results. In case of measurement of a device(s), a user is only responsible for the placement of a single or multiple test devices, adjusting initial settings and starting the measurements. As a result, thermal, optical and electrical design of future photonics products can be greatly facilitated by an engineer in an affordable manner with the help of junction temperature measurements.

In one embodiment of the present invention, the system further comprises a robotic arm. The robotic arm provides easiness for multi-chip LED applications' measurements. It allows easily controlling multi-chips over a board without opening the oven and setting the connections again. This robotic arm can apply current/voltage for each LED chips (for which it is connected) from their solder points from the same or another power supply/source meter individually. For such cases, the multi-chip LED board to be measured is placed at a previously defined location in the test chamber. Then, the robotic arm's position is adjusted by internal software, thus the arm can easily moves from one LED chip to another one during the measurements to give/read current/voltage. Thereafter the forward voltage method is applied to each LED chips without disturbing oven and making new connection. So that, the use of a robotic arm enables the individual junction measurement of each LED chip over a multi-chip LED PCB.

A system according to the present invention comprises different devices/parts, namely, a test chamber wherein a thermal management system, temperature sensors, a power supply, source-meter(s), a control system and software package, work together for the measurement of the junction temperature. In a preferred embodiment of the present invention, different devices/parts of the system are all arranged to form a single apparatus for a compact measurement device.

According to the present invention, junction temperature measurement is conducted in two main phases; calibration phase and pulse phase.

The primary goal of the calibration phase is to develop a relationship between the junction temperature of a sample photonics device and forward voltage value at selected temperature under steady state and thermal equilibrium conditions.

The primary goal of the pulse phase is to obtain junction temperature of a photonics device during an actual operating condition by using the transfer function determined in the calibration phase.

According to the working principle of the present invention, after a photonic device to be tested is placed inside the test chamber (1), calibration and pulse test settings are adjusted in the software (7).

Accordingly, one of the advantages of the present invention is that the user has the opportunity to customize a personalized plan for junction temperature measurement by choosing the desired settings for a particular photonics device. In addition to this, most of the process will be facilitated with suggested default settings by the software and user may need to enter only the operating current of a particular photonics device and run the device without any extra action required by user during the measurement. This makes the present system more practical and time saving.

After desired settings are adjusted, measurements are started and measurement history information which includes elapsed time, current temperature inside the oven and whether or not steady state is reached is followed inside the software. Also, it is possible to monitor any warning during the measurement and observe the measurement graph with respect to time.

Settings for test measurements are also defined by default, such as oven temperature for test measurements, delaying time at each operating current application, desired forward voltage range between measurements and desired number of averaged forward voltage values to be accounted for. However, operating current value(s) for the junction temperature measurement should be entered by users since it varies depending on the photonics product.

After these settings are completed, measurements are initiated and information such as elapsed time, current status of being at calibration or test phase and temperature inside the oven are monitored in the software. After the completion of the measurements, results are also monitored in the software in graph and table form or exported in excel file for more detailed data.

When a measurement is started, heaters and coolers on the test chamber walls heat up or cool down the walls and ambient air inside the chamber until reaching a thermal equilibrium and steady state conditions.

As heating or cooling process takes place, temperature measurements are simultaneously made by using highly sensitive temperature sensors attached on various locations inside the chamber in order to give feedback to power supplier or cooler for power requirements of the chamber to reach a certain temperature in an optimum way.

Once the steady state criteria defined in the initial setting is met and thermal equilibrium is reached, calibration measurements are initiated at that certain temperature by applying a very small pulse current to the photonics for very small pulse duration by use of source-meter and corresponding forward voltage value for that temperature is measured. Very small pulse is applied for very small duration in order to prevent any excess heat accumulation at P-N junction of a photonics device. Accordingly, “very small pulse current” or “very small pulse duration” may be mA, or ms, μs levels depending on the device materials and physics.

Since temperature values are uniform with respect to location in thermal equilibrium condition, junction temperature of the photonics is also the same with temperature of other locations. After the same process may be repeated for all temperatures set in the beginning of the process, such as 40°, 60° or 80° (depending on the test device) and regarding forward voltage values are obtained, results are plotted by the software and linear fitting is applied on data points.

Accordingly, the present invention provides a computer-implemented method for measuring the junction temperature of a photonics device by using forward voltage drop of the junction. The steps of the method are described below:
a) placing a photonics device to be tested into a test chamber (1),
b) adjusting calibration and pulse test settings in a software (7) associated with said test chamber (1),
c) performing calibration phase measurements to develop a relationship between the junction temperature of a photonics device and the forward voltage value at a specific temperature,
d) performing pulse phase measurements to obtain the junction temperature of the photonics device during actual operating conditions by using the transfer function determined in step c),

In one embodiment of the present invention, computer-implemented method for measuring the junction temperature of a photonics device comprises the steps of;
a) placing a photonics device or multiple photonics devices to be tested into a test chamber (1) wherein said chamber is configured to keep the temperature of the ambient air inside the test chamber at a certain value,
b) heating up the test chamber by at least one heater, if required cooling down the test chamber by at least one cooler to set a desired temperature,
c) measuring the temperature of the ambient air inside the chamber by at least one temperature sensor, preferably T-type thermocouple,
d) keeping up the temperature of the test chamber at steady-state conditions according to the feedback received by a control system from temperature sensors,
e) performing calibration phase measurements to develop a relationship between the junction temperature of a photonics device and forward voltage value at said temperature,
f) performing pulse phase measurements to obtain the junction temperature of the photonics device during actual operating conditions by using the transfer function determined in step e).

What is claimed is:

1. A system for measuring a junction temperature of at least one photonics device, comprising
a test chamber, wherein the at least one photonics device to be tested is placed inside the test chamber,
at least one heater configured to heat up the test chamber,
at least one temperature sensor configured to measure a temperature of the test chamber,
a source-meter configured to apply a driving current to the at least one photonics device to read a corresponding forward voltage value at the temperature,
e) a power supply,
a control system configured to convert the temperature to digital data and send a feedback to the power supply, and
a software configured to start and control measurements with either predefined default settings or settings entered by a user,
wherein the at least one photonics device comprises a light-emitting diode.

2. The system according to claim 1, further comprising
at least one cooler configured to cool down the test chamber.

3. The system according to claim 1, wherein the at least one heater is located inside the test chamber.

4. The system according to claim 1, comprising
plurality of heaters located on each wall of the test chamber.

5. The system according to claim 1, wherein
the at least one temperature sensor is located inside the test chamber.

6. The system according to claim 1, further comprising
a robotic arm with a plurality of heads allowing an operator to pick a predetermined photonics device out of the at least one photonics device.

7. The system according to claim 6, wherein
the robotic arm has plurality of electrical connectors enabling multi chip board device measurements.

8. The system according to claim 1, wherein
the power supply is configured to supply energy to the at least one heater or the at least one cooler according to the feedback received from the control system for reaching to a predetermined temperature inside the test chamber.

9. A computer implemented method for measuring a junction temperature of a photonics product comprising the following steps:
a) placing the photonics product to be tested into a test chamber,
b) adjusting calibration and pulse test settings in a software associated with the test chamber,
c) performing first calibration phase measurements to develop a relationship between the junction temperature of the photonics product and a first forward voltage value at a first instant temperature of the test chamber,
d) performing first pulse phase measurements to obtain the junction temperature of the photonics product during actual operating conditions by using a first transfer function determined in step c).

10. The computer implemented method according to claim 9, further comprising the following steps:
a) placing at least one photonics device to be tested in the test chamber,
b) heating up the test chamber by at least one heater,
c) measuring a second instant temperature of an ambient air inside the test chamber by at least one temperature sensor,
d) keeping up the second instant temperature of the test chamber at steady-state conditions according to a feedback received by a programmable logic controller from the at least one temperature sensors comprising thermocouples,
e) performing second calibration phase measurements to develop a relationship between a junction temperature of the at least one photonics device and a second forward voltage value at the second instant temperature of the test chamber,
f) performing second pulse phase measurements to obtain the junction temperature of the photonics device during the actual operating conditions by using a second transfer function determined in step e).

11. The computer implemented method according to claim 10, wherein
step c) is conducted by using the at least one temperature sensor located on selected locations of the test chamber.

12. The computer implemented method according to claim 10, wherein
step f) is conducted by applying a series of pulse currents in less than 10 mA for a pulse duration of less than 10 ms.

13. The computer implemented method according to claim 9, wherein
step e) is repeated for at least two different temperatures to record a change profile of forward voltages by varying temperature values.

14. The system according to claim 2, comprising a plurality of heaters located on each wall of the test chamber.
